(19) United States
(12) Patent Application Publication
(10) Pub. No.: US 2026/0044554 A1
(43) Pub. Date: Feb. 12, 2026

(54) DEVICE, SYSTEM, AND METHOD TO ANALYSE A DOCUMENT USING DYNAMIC KEYWORD DICTIONARY

(71) Applicant: IRSYS Corporation, Schaumburg, IL (US)

(72) Inventor: Arvind Arumugam Murugan, Chennai (IN)

(21) Appl. No.: 19/297,847

(22) Filed: Aug. 12, 2025

(30) Foreign Application Priority Data
Aug. 12, 2024 (IN) 202411061006

(51) Int. Cl. G06F 16/34; G06F 40/242; G06F 40/279

(52) U.S. Cl. CPC G06F 16/345; G06F 40/242; G06F 40/279

(57) ABSTRACT

The present invention discloses a device (100), a system (200), and a method (300) for analysing a document received from one or more users. The invention includes a system (200) for document analysis. The system (200) comprises a user interface (101) to interact with users. The user interface (101) generates queries and receives documents from users. The documents are then transmitted to a device (100) equipped with processors (102) for analysis. The processors (102) extract key sections from the document, prioritize them, remove noisy data, and generate a summary. An interactive tool (105) within the user interface (101) facilitates user feedback on the analysis. The user feedback is used to update a keyword dictionary (104) at predetermined intervals, allowing the system (200) to continuously improve its document analysis capabilities.

### TECHNICAL FIELD

The embodiments of the present disclosure generally relate to the field document processing, more specifically to a device, system, and method for analysing documents using a dynamic keyword dictionary.

### BACKGROUND

Background description includes information that may be useful in understanding the present invention. It is not an admission that any of the information provided herein is prior art or relevant to the presently claimed invention, or that any publication specifically or implicitly referenced is prior art.

The existing technologies of document analysis primarily rely on traditional natural language processing (NLP) techniques and machine learning models. The existing document analysis systems face hurdles in accuracy, adaptability, and continuous improvement. Extracting and prioritizing relevant sections within a document can be difficult, especially for complex or technical content. Additionally, the existing systems need to be adaptable to various document formats and writing styles. Finally, the ideal system should continuously learn and improve its performance based on user interactions and new data encountered over time.

Further, existing systems often lack understanding of the technical jargon due to the simple analysing method used, resulting in summaries that may miss critical nuances or prioritize less relevant information. Many existing solutions rely on fixed keyword lists for text extraction summarization due to a lack of dynamic updation of new keywords, which do not adapt to new or industry-specific terminology, leading to suboptimal summarization accuracy. Also, traditional systems struggle to handle large volumes of documents efficiently due to slow processing time and limited memory space leading makes them impractical to use in large organization that deals with high document throughput. Most of the existing solutions do not incorporate mechanisms for continuous improvement through user feedback, limiting their ability to evolve and improve over time. Further, the integration with advanced AI models, such as private language models (LMs), is often limited or non-existent, reducing the depth and sophistication of the analysis and insights generated.

Furthermore, current methods often rely on keyword extraction or traditional NLP techniques. However, keyword-based approaches can be misled by irrelevant keywords and miss important information. Similarly, traditional NLP techniques might struggle with complex sentence structures or specialized languages used in specific domains. Furthermore, supervised machine learning models often require vast amounts of labeled training data, which can be expensive and time-consuming to collect. Hence, there is a need for a more advanced system that combines sophisticated text extraction and NLP techniques with AI-driven analysis to address the above-mentioned limitations.

A prior-art reference “WO,1993,024,892, A1” titled “Methods and apparatus for quote processing” discloses an apparatus and method for processing quote requests for the procurement of goods and services. The quote processing system is capable of automatically processing quote requests for goods or services from a plurality of customers and facilitates the identification of a plurality of potential suppliers of particular goods or services. The system also automatically generates price request documents which can be sent to a selected number of the identified suppliers. After receiving responses to the price requests, the system can also generate a customer report that informs the customer of the lowest price available for the goods or services requested. The referenced prior art focuses on a quote processing system for automatically processing quote requests, identifying suppliers, generating price requests, and providing customer reports.

Whereas, the present disclosure discloses a device, a system, and a method for document analysis. The disclosed system comprises a user interface to interact with users. The user interface generates queries and receives documents from users. The documents are then transmitted to a device equipped with processors for analysis. The processors extract key sections from the document, prioritize key sections, remove noisy data, and generate a summary. An interactive tool within the user interface facilitates user feedback on the analysis. The user feedback is used to update a keyword dictionary at predetermined intervals, allowing the system to continuously improve its document analysis capabilities.

To address the above-mentioned limitations, there is a need for a more advanced system that combines sophisticated text extraction and NLP techniques with AI-driven analysis. Thus, there exists a dire need in the art, to provide a device, a system, and a method for analysing documents and thereby assist the user in making informed decisions.

### OBJECTS OF INVENTION

Some of the objects of the present disclosure, that at least one embodiment herein satisfies are as listed herein below.

It is a general object of the present disclosure to overcome the drawbacks and limitations of the existing document summarization and analysis systems.

It is an object of the present disclosure to provide a device, a system, and a method to analyse the documents.

It is an object of the present disclosure to provide a device, a system, and a method with generative artificial intelligence (AI) capabilities to enhance the depth and breadth of analysis of documents, generate the summary based on the analysed document, and thereby enabling users to query the summarized documents for detailed insights and facilitating informed decision-making based on the analysed documents.

It is another object of the present invention to provide a device, a system, and a method to accurately extract and process text from various formats of the documents to prepare the same for the summarization and provide the analysis of the received documents.

It is another object of the present disclosure to provide a device, a system, and a method to interact with the users thereby updating the keyword dictionary based on the received feedback from the users.

It is another object of the present disclosure to provide a system for document analysis thereby providing a comprehensive solution to ensure that extracted key sections are clean, well-organized, and retain essential information necessary for effective analysis for the subsequent phases.

### SUMMARY

Within the scope of this application, it is expressly envisaged that the various aspects, embodiments, examples, and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

Aspects of the invention relate to a device, a system, and a method for summarizing and analysing the documents. The invention enhances the analysis process of the documents using an AI-powered chatbot. The invention utilizes a two-phase approach: the first phase involves extracting and processing text from documents, ensuring that the content is clean, well-structured, and ready for summarization. The second phase integrates the processed text with an external private language model (LM) service to generate detailed, domain-specific insights.

The invention includes the use of a dictionary of keywords to identify and prioritize important sections of documents, thereby minimizing the tokens needed for summarization and improving efficiency. The dictionary is continuously updated based on interactions with a private LLM chatbot, where industry experts can ask questions and refine the dictionary through their feedback. This adaptive mechanism ensures that the summaries become more accurate and relevant over time. The system also includes an initial training phase using documents provided by companies or individuals, enhancing the model's accuracy. By combining sophisticated text extraction, NLP techniques, and AI-driven analysis, this invention provides a powerful tool for businesses to evaluate documents to make informed decisions.

Further, the proposed invention provides a device, a system, and a method for analysing documents. The device includes a processor for extracting and processing text from documents to prepare it for summarization and provide a general summary. Further, the processed text with an external LLM service generates detailed domain-specific insights and allows for customer-specific insights. The invention includes a dynamic keyword dictionary that is continuously updated based on user interactions with the AI chatbot. The adaptive mechanism ensures that the summaries provided during phase one become more accurate and relevant over time. Further, the invention incorporates a dynamic dictionary of keywords, continuously updated through interactive feedback from industry experts, and leverages advanced private language models to provide deeper insights and more accurate summaries. The integration of a chatbot for real-time user interaction and feedback can further enhance the proposed system's adaptability and relevance, making it a valuable tool for businesses evaluating documents.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that the invention of such drawings includes the invention of electrical components, electronic components or circuitry commonly used to implement such components.

FIG. 1 illustrates an exemplary block diagram of the device to analyse the document, in accordance with an exemplary embodiment of the present disclosure.

FIG. 2 illustrates an exemplary block diagram of the system to analyse the documents, in accordance with an exemplary embodiment of the present disclosure.

FIG. 3 illustrates an exemplary flow diagram that describes the step-wise illustration of the method for analysing the documents, in accordance with an embodiment of the present disclosure.

Other objects, advantages, and novel features of the invention will become apparent from the following more detailed description of the present embodiment when taken in conjunction with the accompanying drawings.

### DETAILED DESCRIPTION

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Various methods described herein may be practiced by combining one or more machine-readable storage media containing the code/instruction according to the present invention with appropriate standard device hardware to execute the instruction contained therein. An apparatus for practicing various embodiments of the present invention may involve one or more computers (say server) (or one or more processors within a single computer) and storage systems containing or having network access to computer program(s) coded in accordance with various methods described herein, and the method steps of the invention could be accomplished by modules, devises, routines, subroutines, or subparts of a computer program product.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limit the present disclosure.

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Accordingly, an embodiment of the present disclosure, a system, and a method is disclosed.

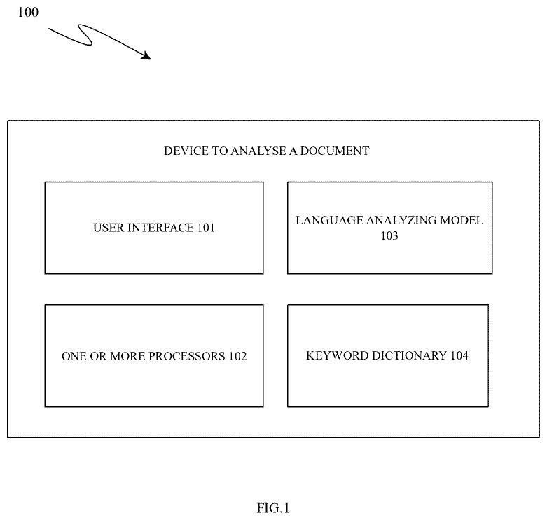

Hereinafter, exemplary embodiments of the present disclosure will be described with reference to the accompanying drawings FIGS. 1-3.

FIG. 1 illustrates an exemplary block diagram (100) of the device to analyse the document, in accordance with an exemplary embodiment of the present disclosure. The present disclosure relates to a device for analysing one or more documents received from the users. The present disclosure relates to a device for analyzing a document. The device (100) is configured to extract key information from a document and present it in a summarized and refined manner.

The device (100) comprises a user interface (101). The user interface (101) is used for interaction with users to submit documents for analysis. The user interface (101) can be implemented in various forms, such as a web application, a mobile application, or a dedicated software program with a graphical user interface. Users can upload documents in various formats, such as text files, PDFs, or scanned images, through the user interface (101).

The device (100) further comprises one or more processors (102) coupled to the user interface (101). These processors (102) are the central processing units responsible for analyzing the received documents. The processors (102) are configured to perform several key operations.

Firstly, the processors (102) are configured to extract one or more key sections from the received document. This extraction process may involve identifying sections with high information density, such as headings, subheadings, bullet points, or tables. Additionally, the processors (102) may utilize natural language processing techniques to identify sections with high semantic importance based on the context of the document.

Secondly, the processors (102) prioritize the extracted key sections from one or more remaining terms in the document. This prioritization can be achieved by assigning a higher weight to key sections based on their relevance to a specific topic or by employing machine learning algorithms trained to identify the most significant sections within the document.

Thirdly, the processors (102) process the prioritized key sections to remove one or more noisy data. Noisy data can encompass irrelevant or misleading information such as advertisements, footnotes, or boilerplate text. The processors (102) may utilize various techniques to remove noisy data, such as regular expressions, keyword filtering, or machine learning algorithms trained to identify irrelevant content.

Following the processing of key sections, the processors (102) generate a summary of the processed key sections. This summary condenses the most important information from the document into a concise and informative format. The summary may be generated through various methods, including sentence extraction algorithms, summarization techniques based on key phrases, or a combination of both.

Finally, the device (100) incorporates a language analysing model (103). This language analyzing model (103) analyzes the generated summary of the key sections. Based on the analysis, the language analyzing model (103) updates a keyword dictionary (104). The keyword dictionary (104) is a repository of keywords and their associated weights or importance scores. By analyzing the summary, the language analyzing model (103) can identify new keywords or refine the weights of existing keywords within the keyword dictionary (104). This updated keyword dictionary (104) is then communicatively connected to the processors (102). This communication allows the processors (102) to leverage the updated keyword dictionary (104) when analyzing subsequent documents received from users.

In essence, the device (100) operates by extracting and prioritizing key information from a document, removing irrelevant details, and generating a concise summary. The device also employs a continuous learning mechanism through the language analyzing model (103) and the keyword dictionary (104) to improve its analysis capabilities over time. The device (100) acts as a comprehensive solution to analyse the documents received from the users.

In an embodiment, the language analyzing model (103) is selected from any or combination of artificial intelligence (AI) model, large language model (LLM), natural language processing (NLP) model, machine learning (ML) model, statistical language model, federated learning model, Recurrent Neural Networks (RNNs), encoder-decoder model, generative adversarial networks (GANs).

In these embodiments, the language analyzing model (103) is configured to provide one or more domain-specific insights associated with the received document from one or more users and fine-tuned with one or more contrastive learning methods to analyze and generate the summary of the document.

One or more key sections are selected by comparing each term of the received document with one or more terms present in a pre-defined list of keywords pre-stored in the keyword dictionary (104).

In an embodiment, the noisy data may include any information in the document received by the user interface (100) that can potentially mislead the analysis and generation of a summary of the document. The noisy data may originate from various components and sources such as the user interface (101).

In an embodiment, the present invention is used as a device, a system, and a method for summarizing Request for Quotation (RFQ) documents and enhancing the analysis process using an AI-powered chatbot. The system employs a two-phase approach: the first phase involves extracting and processing text from RFQ documents, ensuring that the content is clean, and well-structured, and doing basic summarization. The second phase integrates the processed text with an external private Large Language Model (LM) service to generate detailed domain-specific insights that a user requires.

In these embodiments, the keyword dictionary is enhanced based on the user interactions and specific document contexts. The user interactions with interactive tools such as the AI chatbot are used to track analyse identify commonly used terms and phrases in user queries and add relevant terms to the keyword dictionary categorized by document type and field.

In these embodiments, the device (100 leverages advanced NLP techniques and LLM services to provide deep, domain-specific insights from the processed document content.

In these embodiments, the device (100) uses transformer-based architectures for improved semantic analysis and understanding. Apply models such as BERT, GPT-4, or other advanced LLMs to generate detailed summaries and insights. Implement contrastive learning methods for fine-tuning the LLM, ensuring high compatibility and accuracy with the specific documents.

In these embodiments, the device (100) includes tracking and analysing user interactions with the AI chatbot to identify commonly used terms. If a significant number of users ask about “hardware requirements” in IT-related RFQs, the term is added to the keyword dictionary. When summarizing future IT RFQs, the system intelligently segments and prioritizes sections covering hardware requirements.

In these embodiments, the device (100) executes and integrates both advanced NLP techniques and external LLM services to enhance the summarization and analysis of RFQ documents. By leveraging user interactions and feedback to dynamically update the keyword dictionary, the system (200) ensures accurate and relevant summaries tailored to specific document contexts. The adaptive and intelligent approach provides businesses with powerful tools for informed decision-making, marking a significant advancement in the field of RFQ document analysis.

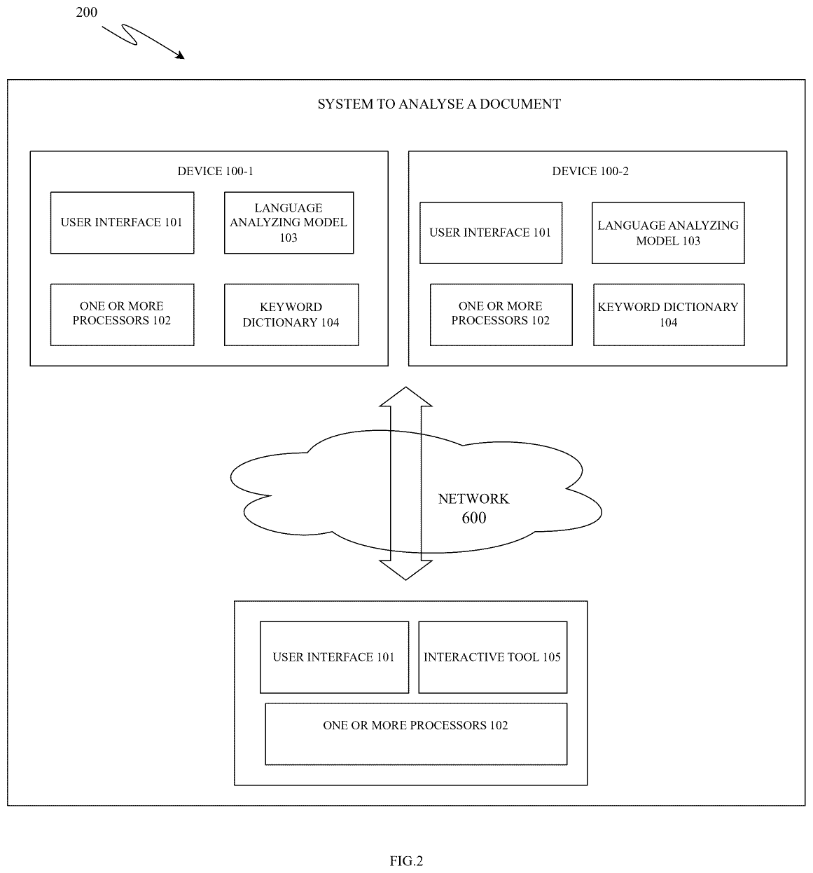

FIG. 2 illustrates an exemplary block diagram of the system (200) to analyse the documents, in accordance with an exemplary embodiment of the present disclosure.

The present disclosure relates to a system (200) for analyzing documents. The system (200) facilitates a user-interactive document analysis process by combining a user interface (101) with a document analysis device (100).

The system (200) comprises a user interface (101). The user interface (101) facilitates between users and the device (100).

In an embodiment, the user interface (101) can be implemented in various forms, such as a web application, a mobile application, or a dedicated software program with a graphical user interface.

The user interface (101) is configured to perform two functions. Firstly, it can generate one or more queries to be presented to users. These queries can be designed to guide users in the document submission process. For instance, the user interface (101) may prompt users to upload a specific document type or ask clarifying questions about the document content.

Secondly, the user interface (101) is configured to receive documents from users in response to the generated queries. Users can upload documents in various formats, such as text files, PDFs, or scanned images, through the user interface (101).

Following the document received, the user interface (101) transmits the received document to a device (100). The document analysis device (100) comprises one or more processors (102) coupled to the user interface (101). The processors (102) are responsible for analyzing the received documents.

The device (100) operates as described previously. The processors (102) extract one or more key sections from the received document, prioritize these sections, process them to remove noisy data, generate a summary, and utilize a language analyzing model (103) to update a keyword dictionary (104) based on the analysis. A detailed description of these functionalities can be found in the preceding section.

The keyword dictionary (104) is communicatively connected to the processors (102) within the document analysis device (100) which allows the processors (102) to leverage the updated keyword dictionary (104) when analyzing subsequent documents received from users through the user interface (101).

In essence, the system (200) provides a user-friendly platform for document analysis. The user interface (101) guides users in submitting relevant documents, while the device (100) efficiently extracts key information and presents it in a concise and informative manner. The system (200) also incorporates a continuous learning mechanism through the language analyzing model (103) and the keyword dictionary (104), ensuring improved analysis capabilities over time.

In an embodiment, one or more queries are generated through an interactive tool (105), and one or more feedbacks are received through one or more users thereby updating the keyword dictionary at a pre-determined period, wherein the interactive tool (105) is communicatively connected to the user interface (101).

In an embodiment, the interactive tool (105) may be selected from any or a combination of survey platforms, chatbots with feedback functionality, user research platforms, social listening tools, live chat with feedback capture, and chat-based feedback widgets.

In these embodiments, the interactive tool (105) includes but is not limited to chatGPT, gemini AI, bard, jurassic-1 jumbo, jasper, rytr, gitHub, copilot, tabnine, perplexity.ai, and neeva.

In these embodiments, the interactive tool (105) can be used for guided search, interactive summarization, feedback mechanism, or for query refinement.

In these embodiments, one or more key sections are selected by comparing each term of the received document with one or more terms present in a pre-defined list of keywords pre-stored in the keyword dictionary (104).

In these embodiments, the language analyzing model (103) is selected from any or combination of artificial intelligence (AI) model, large language model (LLM), natural language processing (NLP) model, machine learning (ML) model, statistical language model, federated learning model, Recurrent Neural Networks (RNNs), encoder-decoder model, generative adversarial networks (GANs).

In an embodiment, the device (100) includes tracking and analysing user interactions with the AI chatbot to identify commonly used terms. If a significant number of users ask about “hardware requirements” in IT-related RFQs, the term is added to the keyword dictionary. When summarizing future IT RFQs, the system intelligently segments and prioritizes sections covering hardware requirements.

In these embodiments, the system (200) may utilize below broad workable parameters.

For text Extraction Accuracy: Range: 90% to 99%, Description: The parameter indicates the accuracy of extracting text from RFQ documents, whether through direct extraction from digital formats or OCR from scanned documents.

For OCR Resolution: Range: 300 DPI to 600 DPI, Description: The resolution at which scanned RFQ documents are processed to ensure clear text extraction. Higher DPI values improve OCR accuracy.

For token usage for summarization: Range: 10% to 30% of the original document tokens, Description: The percentage of original document tokens used in the summarization process, optimized to balance efficiency and comprehensiveness.

For keyword dictionary size: Initial Range: 500 to 2000 keywords, Dynamic Range: 500 to 5000 keywords, Description: The size of the keyword dictionary used to identify important sections of RFQ documents. The dictionary can grow dynamically as new keywords are added through user feedback.

For chatbot interaction frequency: Range: 1 to 10 interactions per RFQ document, Description: The number of interactions between the AI-powered chatbot and the user per RFQ document to refine the keyword dictionary and improve the summarization model.

For document processing speed: Range: 1 to 5 minutes per RFQ document, Description: The time required to process an RFQ document through extraction, cleanup, segmentation, and summarization.

For user feedback incorporation frequency: Range: weekly to monthly updates Description: The frequency at which user feedback is incorporated into the system to update the keyword dictionary and improve the summarization model.

For natural language processing (NLP) model accuracy: ⋅Range: 85% to 98% ⋅Description: The accuracy of NLP models used for semantic analysis, text segmentation, and content filtering within the RFQ documents.

For data transmission security: Encryption Range: AES-128 to AES-256 Description: The level of encryption used for secure data transmission between the summarization pipeline and the in-house language model.

For model training data volume: Range: 100 to 1000 RFQ documents Description: The number of RFQ documents used to initially train the summarization model, enhancing its accuracy and relevance.

For summarization length: Range: 10% to 25% of the original document length, Description: The length of the summary compared to the original RFQ document, providing a concise yet comprehensive overview.

For feedback loop improvement rate: Range: 5% to 20% improvement per iteration, Description: The rate of improvement in the system's summarization accuracy and relevance after each feedback loop iteration.

The above-mentioned ranges provide flexibility while ensuring the system remains effective and efficient in summarizing and analyzing RFQ documents. Adjustments within these ranges can be made based on specific use cases and operational requirements.

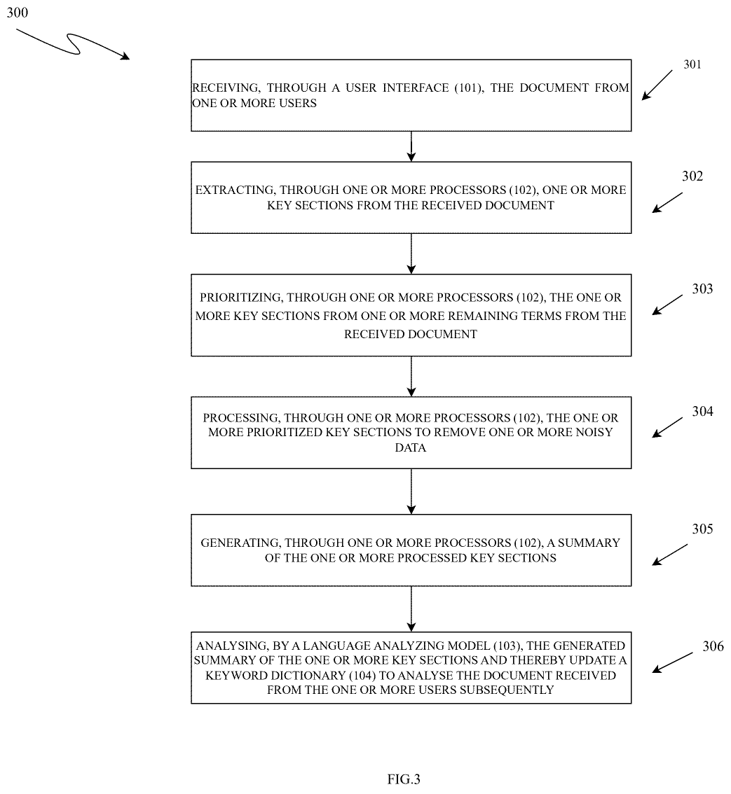

FIG. 3 illustrates an exemplary flow diagram that describes the step-wise illustration of the method (300) for analysing the documents, in accordance with an embodiment of the present disclosure.

The present disclosure relates to a method (300) for analyzing documents. The method (300) illustrates a step-by-step process for extracting key information from a document received from the user.

The method (300) commences with receiving (301) the document from one or more users. The reception of documents occurs through a user interface (101). The user interface (101) can be implemented in various forms, such as a web application, a mobile application, or a dedicated software program with a graphical user interface. Users can upload documents in various formats, such as text files, PDFs, or scanned images, through the user interface (101).

Following the document received, the method (300) involves extracting (302) one or more key sections from the received document. The extraction process is performed by one or more processors (102) coupled to the user interface (101). The processors (102) are the central processing units responsible for analyzing the document. Extraction of key sections can involve identifying sections with high information density, such as headings, subheadings, bullet points, or tables. Additionally, the processors (102) may utilize natural language processing techniques to identify sections with high semantic importance based on the context of the document.

After extracting key sections from the received document, the method (300) prioritizes (303) the key sections from one or more remaining terms in the document. This prioritization is also performed by the processors (102). Assigning a higher weight to key sections based on their relevance to a specific topic or employing machine learning algorithms trained to identify the most significant sections within the document are two possible methods for prioritization.

The method (300) then proceeds with processing (304) the prioritized key sections to remove one or more noisy data.

Noisy data encompasses irrelevant or misleading information such as advertisements, footnotes, or boilerplate text. Various techniques can be employed by the processors (102) for noise removal, such as regular expressions, keyword filtering, or machine learning algorithms trained to identify irrelevant content.

Following the processing of key sections, the method (300) involves generating (305) a summary of the processed key sections. This summary condenses the most important information from the document into a concise and informative format. The processors (102) are responsible for generating the summary. Sentence extraction algorithms, summarization techniques based on key phrases, or a combination of both can be utilized to generate the summary.

Finally, the method (300) incorporates a language analyzing model (103) for further analysis. The model (103) analyzes (306) the generated summary of the key sections. Based on the analysis, the language analyzing model (103) updates a keyword dictionary (104).

The keyword dictionary (104) is a repository of keywords and their associated weights or importance scores. By analyzing the summary, the language analyzing model (103) can identify new keywords or refine the weights of existing keywords within the keyword dictionary (104). This updated keyword dictionary (104) is then communicatively connected to the processors (102). This communication allows the processors (102) to leverage the updated keyword dictionary (104) when analyzing subsequent documents received from users through the user interface (101).

In essence, the method (300) provides a structured approach to document analysis. It extracts and prioritizes key information from a document, removes irrelevant details, and generates a concise summary. The method (300) also employs a continuous learning mechanism through the language analyzing model (103) and the keyword dictionary (104) to improve its analysis capabilities over time.

In another embodiment, the method (300) includes various stages such as direct extraction, OCR Extraction, and processing stages, which include cleanup, segmentation, content filtering, and section prioritization which are illustrated below.

In these embodiments, the stage of direct extraction is Tailored for digital documents in text-readable formats such as PDFs and DOCX files. It utilizes Python libraries such as PyPDF2 and python-docx, selected for their efficiency in extracting text while preserving the original document's formatting and structure. At this stage, the text is extracted while maintaining the document's original formatting, managing document encryption and complex layouts to ensure comprehensive text capture without altering the content.

At the stage of OCR extraction, the essential scanned documents or image-based content are crucial for digitizing printed materials or handwritten notes within RFQ submissions. It further employs OCR tools like Tesseract, known for its superior image-to-text conversion capabilities, accuracy, extensive language support, and open-source availability. The stage enhances image resolution and reduces noise to improve OCR accuracy, convert images to text using OCR, and conduct layout analysis to interpret the document structure accurately.

The processing steps first start with cleanup. The cleanup includes removing irrelevant elements such as headers, footers, and page numbers from the extracted text, focusing on essential content. It Utilizes automated techniques with regular expressions and layout analysis tools, supplemented with advanced NLP for semantic analysis to ensure the exclusion of non-essential elements without losing important details. It implements domain-specific preprocessing to filter irrelevant parts based on dependency tree patterns, preserving semantically relevant meaning and syntactic correctness.

At the stage of segmentation, the texts from the documents are broken into logical units such as sentences and paragraphs to facilitate easier analysis and summarization. It leverages NLP libraries like NLTK or SpaCy, incorporating sophisticated functions for accurate text segmentation, ensuring the text is parsed into coherent segments that can be analysed and summarized effectively. It utilizes transformer-based architectures with cross-segment attention for improved segmentation accuracy.

The content filtering stage includes the exclusion of non-essential content such as figures, tables, and external references, concentrating on textual information crucial for understanding the documents. Content filtering is done by developing custom algorithms and pattern recognition informed by semantic analysis to focus on filtering out irrelevant content, ensuring the focus remains on substantial information.

In an embodiment, the system (200) uses the application of the Masked Document Embedding Rank (MDERank) approach for unsupervised key phrase extraction to identify and filter relevant content based on semantic similarity.

Section prioritization involves the identification of the most relevant sections of the document, aligning with the summarization goals. It employs a set of instructions to analyse section titles and content relevance, using semantic similarity calculations (e.g., BERT embeddings) to determine the importance of each section accurately.

In an embodiment, the section prioritization incorporates the visual layout (VILA) group modeling technique to enhance section prioritization by recognizing text blocks and layout structures.

In these embodiments, the present invention seamlessly integrates the processed and summarized document with an advanced Large Language Model (LLM) service. The integration harnesses generative AI capabilities to enhance the depth and breadth of analysis available for each RFQ, enabling users to query the summarized documents for detailed insights and facilitating informed decision-making.

In an embodiment, the method (300) includes a robust application programming interface (hereinafter “API”) to enable secure and efficient communication between the internal document summarization pipeline and external large language model (hereinafter “LLM”) services.

In these embodiments, the method (300) establishes protocols for data transmission, authentication, and error handling. Ensure the API is scalable to handle varying data loads and adaptable to potential changes in LLM services or the internal pipeline.

In these embodiments, the method (300) includes standardization of the data format of summarized documents to ensure compatibility with external LLM services. It defines a schema for the summarized data in JSON or XML format, detailing the structure, encoding, and serialization of the data to be exchanged. Include necessary metadata and contextual information to enhance the accuracy of generative insights.

In these embodiments, the method (300) includes handling and integrating the responses from the LLM services into the decision-making workflow. The method (300) further steps such as parsing, interpreting, and presenting the generative outputs from the LLM in a user-friendly manner, highlighting key decision factors, risks, and opportunities within each document.

In these embodiments, the method (300) includes an adaptive feedback mechanism. The method (300) includes continuous refinement of the keyword dictionary and summarization model based on user interactions and feedback. The method is the step of monitoring user queries and feedback to identify common themes and terms. Update the keyword dictionary dynamically to include frequently used terms and phrases, enhancing the relevance and accuracy of future summaries.

In these embodiments, communication port(s) are configured to enable communication between the device (100) and external entities. The ports may include RS-232 ports, Ethernet ports, Gigabit ports, serial ports, parallel ports, or other interfaces tailored to networking requirements, depending on the specific network configuration. The bus acts as a communication channel that facilitates the exchange of data and instructions between the processor and other components within the system, such as memory, storage, and communication blocks. Common bus standards may encompass PCI/PCI-X, SCSI, USB, or similar protocols, ensuring compatibility and interoperability.

In these embodiments, typically, the device (100), system (200), or any module thereof is configured to communicate with one or more external computing devices, which may include a computer processor of a local computing device such as a smartphone, a tablet device, and/or a personal computer, and/or a remote computing device or a remote server, e.g., a cloud-based remote server. For example, external computing devices may receive data from the user system and may then process the data through the processing unit (104), for example, using techniques as described herein. Alternatively, or additionally, the external computing device may send data and/or instructions through the device (100). The present disclosure includes references to certain functionalities being performed by a computing device. Typically, such functionalities are performed by the processing unit, external computing devices, and/or a combination thereof.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the scope of the present invention, and all such modifications as would be obvious to one skilled in the art are intended to be included within the scope of the following claims.

### ADVANTAGES OF THE INVENTION:

The proposed invention provides a device to analyse the documents received from the user.

The proposed invention provides a device, a system, and a method implemented to facilitate users by generating queries and receiving feedback thereby improving the analysis and summarization of the documents.

The proposed invention provides a device that represents a significant advancement in the field of document summarization and analysis.

The proposed invention provides a system that offers a comprehensive solution for

[symbol]

We claim:

1. A device (100) to analyse a document, the device (100) comprising:
a user interface (101) to receive the document from one or more users;
one or more processors (102) coupled to the user interface (101), wherein the one or more processors (102) are configured to:
extract one or more key sections from the received document;
prioritize the one or more key sections from one or more remaining terms from the received document;
process the one or more prioritized key sections to remove one or more noisy data;
generate a summary of the one or more processed key sections; and
analyse, by a language analyzing model (103), the generated summary of the one or more key sections and thereby update a keyword dictionary (104) to analyse the document received from the one or more users subsequently, wherein the keyword dictionary (104) is communicatively connected with the one or more processors (102).

2. The device (100) as claimed in claim 1, wherein the language analyzing model (103) is selected from any or combination of artificial intelligence (AI) model, large language model (LLM), natural language processing (NLP) model, machine learning (ML) model, statistical language model, federated learning model, Recurrent Neural Networks (RNNs), encoder-decoder model, generative adversarial networks (GANs).

3. The device (100) as claimed in claim 1, wherein the one or more key sections are selected by comparing each term of the received document with one or more terms present in a pre-defined list of keywords pre-stored in the keyword dictionary (104).

4. The device (100) as claimed in claim 1, wherein the language analyzing model (103) is configured to provide one or more domain-specific insights associated with the received document from the one or more users and fine-tuned with one or more contrastive learning methods to analyze and generate the summary of the document.

5. A system (200) to analyse a document, the system (200) comprising:
a user interface (101) to:
generate one or more queries to one or more users;
receive the document from one or more users in response to the one or more queries;
transmit the received document to a device (100), wherein the device (100) comprises one or more processors (102) coupled to the user interface (101), wherein the one or more processors (102) are configured to:
extract one or more key sections from the received document; and
prioritize the one or more key sections from one or more remaining terms from the received document;
process the one or more prioritized key sections to remove one or more noisy data;
generate a summary of the one or more processed key sections; and
analyze, by a language analyzing model (103), the generated summary of the one or more key sections and thereby update a keyword dictionary (104) to analyse the document received from the one or more users subsequently, wherein the keyword dictionary (104) is communicatively connected with the one or more processors (102).

6. The system (200) as claimed in claim 5, wherein the one or more queries are generated through an interactive tool (105) and one or more feedbacks are received from the one or more users in response to the one or more queries thereby update the keyword dictionary at pre-determined period, wherein the interactive tool (105) is communicatively coupled to the user interface (101).

7. The system (200) as claimed in claim 5, wherein the one or more key sections are selected by comparing each term of the received document with one or more terms present in a pre-defined list of keywords pre-stored in the keyword dictionary (104).

8. The system (200) as claimed in claim 5, wherein the language analyzing model (103) is selected from any or combination of artificial intelligence (AI) model, large language model (LLM), natural language processing (NLP) model, machine learning (ML) model, statistical language model, federated learning model, Recurrent Neural Networks (RNNs), encoder-decoder model, generative adversarial networks (GANs).

9. A method (300) to analyse a document, the method (300) comprising:
receiving (301), through a user interface (101), the document from one or more users;
extracting (302), through one or more processors (102), one or more key sections from the received document, wherein one or more processors (102) coupled to the user interface (101);
prioritizing (303), through one or more processors (102), the one or more key sections from one or more remaining terms from the received document;
processing (304), through one or more processors (102), the one or more prioritized key sections to remove one or more noisy data;
generating (305), through one or more processors (102), a summary of the one or more processed key sections; and
analysing (306), by a language analyzing model (103), the generated summary of the one or more key sections and thereby update a keyword dictionary (104) to analyse the document received from the one or more users subsequently, wherein the keyword dictionary (104) is communicatively connected with the one or more processors (102).

10. The method (300) as claimed in claim 9, wherein the language analyzing model (103) is selected from any or combination of artificial intelligence (AI) model, large language model (LLM), natural language processing (NLP) model, machine learning (ML) model, statistical language model, federated learning model, Recurrent Neural Networks (RNNs), encoder-decoder model, generative adversarial networks (GANs).
